(19) United States
(12) Patent Application Publication
(10) Pub. No.: US 2004/0135804 A1
(43) Pub. Date: Jul. 15, 2004

(54) Method and apparatus for providing laboratory logistics information

(76) Inventors: Emanuele Rodigari Pellaz, Avully (CH); John Marolf, Hout Bay (ZA); Maria Taboada, Croix-de-Rozon (CH); Michael Mitchell, Indianapolis, IN (US); James Harkness, Versoix (CH)

Correspondence Address: James Wiegund, Esq., McDERMOTT, WILL & EMERY, 28 State Street, Boston, MA, 02109, US

(21) Appl. No.: 10/340,059

(22) Filed: Jan. 10, 2003

(51) Int. Cl. G09G 5/00

(52) U.S. Cl. 345/734

(57) ABSTRACT

A system includes a controller and a network interface that provides access to laboratory logistics information. An operator may access the system through a graphical user interface that provides interactive geographic navigation of locations and services that may be used in the transportation of biological samples from a protocol participant's site to a central laboratory.

### FIELD OF THE INVENTION

The invention relates to laboratory logistics and, more particularly, to the presentation of logistics information.

### BACKGROUND OF THE INVENTION

Medical protocol participants may be widely dispersed and have access to widely varying local services that employ disparate procedures. Central laboratories are employed to analyze samples that are obtained from widespread, even worldwide, locations, in order to insure the accuracy and consistency of analytical results. Given the differences in physical and political landscapes, in transportation facilities, even in business calendars, the logistics involved in transporting biological samples from such diverse regions to one or more centralized laboratories can be quite complex. A system and method that provide logistical information related to the transportation of biological materials through a plurality of geopolitical regions would therefore be highly desirable.

### SUMMARY

An interactive system and method in accordance with the principles of the present invention provide logistical information related to the transportation of biological materials through a plurality of geopolitical regions. Such regions may vary in scope and scale, from worldwide to region, such as the Middle East, to continent, to country, state, canton, province, or city, for example. The system stores logistical information related to transportation-service providers, also referred to herein as “carriers”, that operate in the various geopolitical regions of interest. The system includes an interactive graphical interface that allows a user to navigate the logistical information on the basis of geopolitical regions. Such information may include the names of one or more carriers within a region of interest that provides specific services of interest. That is, for example, a particular protocol may require the transportation of infectious biological samples from a protocol participant in one country to a central laboratory located within another country. A system and method in accordance with the principles of the present invention would permit a user, also referred to herein as an operator, to access logistics information needed to delivery the biological samples from the protocol participant source to a central laboratory destination.

In one aspect of a system and method in accordance with the principles of the present invention, an interactive display presents a graphical interface with which a user may interact to determine the logistical resource options available in the delivery of various biological samples. Such an interactive display may display a world map at a top level and permit a user to navigate through geopolitical regions in order to determine the resources available on a region by region basis. The system may allow access to such information through a network, such as an intranet or an interworking network, such as the Internet. The system may also be used in conjunction with a standalone computer system, such as a laptop computer, in order to be used in a “disconnected mode”.

### BRIEF DESCRIPTION OF THE DRAWINGS

The above and further features, aspects, and advantages of the invention will be apparent to those skilled in the art from the following detailed description, taken together with the accompanying drawings in which:

FIG. 1 is a conceptual block diagram of a system that may be used in the storage, retrieval, and display of logistics information in accordance with the principles of the present invention;

FIG. 2 is a conceptual block diagram of a networked system for the provision of logistics information in accordance with the principles of the present invention;

FIG. 3 is a conceptual screen shot of a top-level interactive display such as may form a home page in a web-based embodiment of a logistics information system in accordance with the principles of the present invention;

FIG. 4 is a conceptual screen shot of a top-level interactive display with “rollover” information displayed in accordance with the principles of the present invention;

FIG. 5 is a conceptual screen shot of an interactive display that allows a user to search for services on the basis of geopolitical regions and desired services;

FIG. 6 is a conceptual screen shot of an interactive display that provides detailed information related to various carriers of interest in a given geopolitical region; and

FIG. 7 is a conceptual screen shot of an interactive display that provides detailed information related to a given carrier for a plurality of selected geopolitical regions (i.e., countries, in this example).

### DETAILED DESCRIPTION

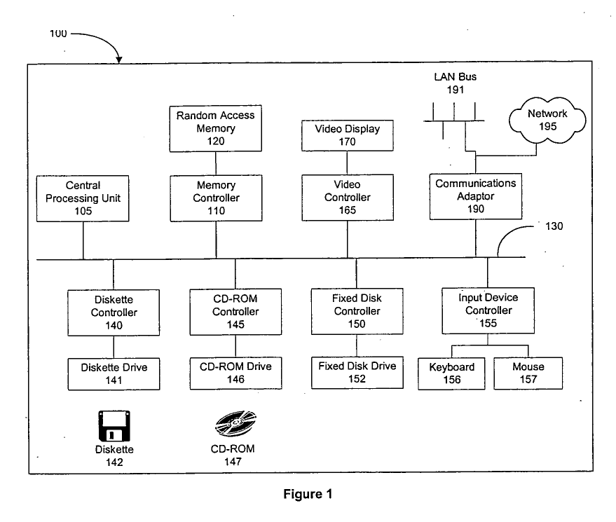

FIG. 1 illustrates the system architecture for a computer system 100 on which the invention may be implemented. The exemplary computer system of FIG. 1 is for descriptive purposes only. Although the description may refer to terms commonly used in describing particular computer systems, the description and concepts equally apply to other systems, including systems having architectures dissimilar to FIG. 1.

Computer system 100 includes a central processing unit (CPU) 105, which may be implemented with a conventional microprocessor and a random access memory (RAM) 110 for temporary storage of information. A memory controller 120 is provided for controlling RAM 110. A bus 130 interconnects the components of computer system 100.

Mass storage may be provided by diskette 142, CD-ROM 147, or fixed disc drive 152. Data and software may be exchanged with computer system 100 via removable media such as diskette 142 and CD ROM 147. Diskette 142 is insertable into diskette drive 141, which is, in turn, connected to bus 130 by a controller 140. Similarly, CD-ROM 147 is insertable into CD ROM drive 146, which is, in turn, connected to bus 130 by controller 145. Fixed disc drive 152 is connected to bus 130 by controller 150.

User input to computer system 100 may be provided by a number of devices. For example, a keyboard 156 and mouse 157 are connected to bus 130 by controller 155. It will be apparent to those reasonably skilled in the art that other devices, such as a pen and/or tabloid may be connected to bus 130 and an appropriate controller and software, as required. A visual display is generated by video controller 165, which controls video display 170. Computer system 100 also includes a communications adaptor 190 which allows the system to be interconnected to a local area network (LAN) or a wide area network (WAN), schematically illustrated by bus 191 and network 195.

Operation of computer system 100 is generally controlled and coordinated by operating system software. The operating system controls allocation of system resources and performs tasks such as processing scheduling, memory management, networking, and I/O services, among things. In particular, an operating system resident in system memory and running on CPU 105 coordinates the operation of the other elements of computer system 100. The present invention may be implemented with any number of commercially available operating systems including, Microsoft Windows™ OS/2™, UNIX™ and DOS™, etc. One or more applications may also run on the CPU 105. If the operating system is a true multitasking operating system, multiple applications may execute simultaneously.

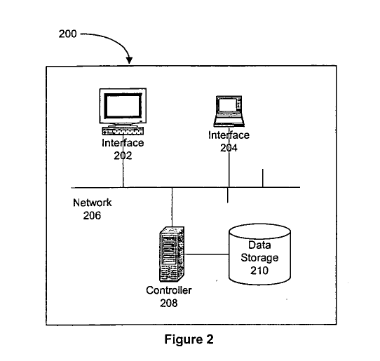

FIG. 2 illustrates conceptually the main components of an interactive display system 200 in accordance with the present invention. One or more operator interfaces, such as interfaces 202 and 204 may each take the form of a known computer system, such as that described in the discussion related to FIG. 1. As such, the operator interface 202 may include various input and output devices, such as a keyboard, mouse, and display. Each operator interface 202,204 may be connected through a network 206 to one or more controllers 208 that provide access to data storage 210. The one or more controllers 208, as well as the one or more data storage systems 210 may be centralized or distributed. Each of the one or more controllers 208, or even the complete system 200 in the case of a standalone disconnected use, may also take the form of a known computer system, such as described in the discussion related to FIG. 1. The data storage 210 may employ any memory technology, present or future, including, but not limited to, semiconductor, magnetic, optical or other memory devices, for the storage of laboratory logistics information. Users may employ an interface 202,204 to access the laboratory logistics information by a connection through the network 206. The network 206 may employ any of a number of hardware technologies, including as twisted pair, coaxial cable, optical fiber; any of several protocols and may include intranet or Internet connections, for example, with any of various types and levels of secure access.

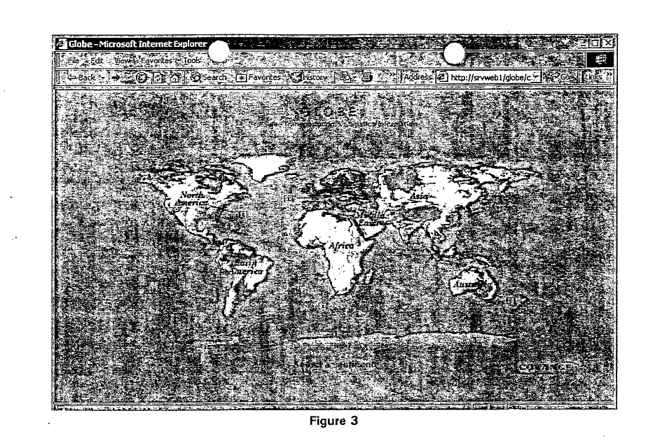

The screen-shot of FIG. 3 illustrates the display of an interactive graphical interface in accordance with the principles of the present invention. The interface allows operators to review and select medical logistics options that may be employed, for example, in the transportation of medical samples from a protocol participant's site to a central laboratory's site. The logistics information may include such things as the names of carriers operating in particular regions and the type of services each carrier provides within a region. The types of service information may include whether the carrier handles particular types of sample, (e.g., infectious/non-infectious, frozen/ambient), or hours and dates of operation, (e.g., non-business day, such as weekend or holiday, pickup services).

In this illustrative embodiment a controller displays a map of the world on an interactive display. In this illustrative embodiment, a worldwide map provides a top-level graphical interface to information related to available medical logistic services. The scope of the displayed map may vary from worldwide to a city neighborhood, or anything in between. Additionally, although this illustrative map is divided into continent-level geopolitical regions, maps employed in accordance with the principles of the invention may be divided into any of a variety of geopolitical regions, including landmass (e.g., Eurasia), continent, continental region, country, country region, province, state, city, or neighborhood, for example. In this illustrative embodiment the globe is divided into the following geopolitical regions: North America, Latin America, Africa, Europe, Middle East, Asia, and Australia. An operator may interact with the system by using a mouse to “click on” a map region, by keyboard entry, or by interacting with pull-down or pop-up menus, for example.

In this illustrative embodiment, the worldwide map of FIG. 3 may be employed as a “home page” that provides various navigational aides to end-users. For example, an operator may click on the “Globe” title, in response to which the system may open a text window (not shown) that enumerates various features and functions available through the interactive display. In this illustrative embodiment, the system may display the types of medical logistics information that a user may obtain using the system. The system's capabilities, such as the ability to navigate geographically on a region-by-region basis (continent-by-continent in this illustrative embodiment) may be displayed here.

A system in accordance with the principles of the present invention permits an operator to obtain medical logistics information by navigating through geopolitical regions, such as the continents in this illustrative top-level display. An operator may click on a continent to obtain continent-wide logistics information or may “drill down” to more and more compact regions such as nations, provinces, cantons, and cities, for example, to obtain information specific to those regions. In an illustrative embodiment, an interactive logistics system includes a web server that presents a worldwide map as a part of its home page. Icons that respond to mouse input by “rolling over” may be distributed throughout the map to provide more detailed information at this top level screen. That is, as a user passes a cursor or other “mouse-location” indicator over an icon, the system responds by displaying a brief description of an associated laboratory. In this illustrative embodiment, a user may use the home-page map, and others, to navigate from higher level descriptions to more detailed descriptions that include, for example, detailed carrier information for selected continents, countries, or-other geopolitical regions. For example in response to the selection of a continent, through a mouse-click, for example, in combination with the selection of various parameters, the system may list countries within the selected geopolitical region that fit the selected parameters. The selected parameters may include specific shipping services, for example. This general information may be displayed, for example, on a single page, that may be referred to herein as a carrier information page. A user may obtain further information through interaction with a carrier information page. For example, a user may select a specific carrier that is listed on the carrier information page in order to obtain detailed information about that carrier, which selection the system will respond to by opening a detailed carrier information page. Or, a user may select a more narrowly focused geopolitical region (e.g., select a country within a continent) to obtain-more detailed information related to that country.

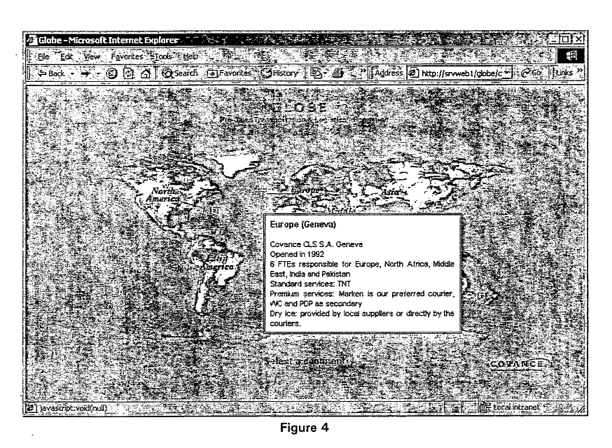

Turning now to the conceptual screen shot of FIG. 4, Icons, such as the illustrated, [i], icons, may be employed by a system in accordance with the principles of the present invention to provide information related to specific laboratory facilities. For example, in this illustrative embodiment, five icons represent five central laboratory locations (Indianapolis, Ind.; Geneva, Switzerland; Cape Town, South Africa; Singapore; and Sydney, Australia). When an operator activates an icon by clicking on it, the system displays text within a window that provides specific information about the laboratory. Such information may include the region serviced by the specific laboratory location. For example, the Indianapolis laboratory may service North, Central, and South America; Geneva service Europe, the Middle East, and North Africa; Cape Town, South Africa; Singapore, Asia; and Sydney, Australia and New Zealand. The displayed information may include the types of services available from various carriers. For example, standard services may be available from such carriers as Fedex™, TNT™, or DHL™. Premium services may be available from carriers, such as Marken™, World Courier™, or QuickStat™ that specialize in handling biomedical shipments.

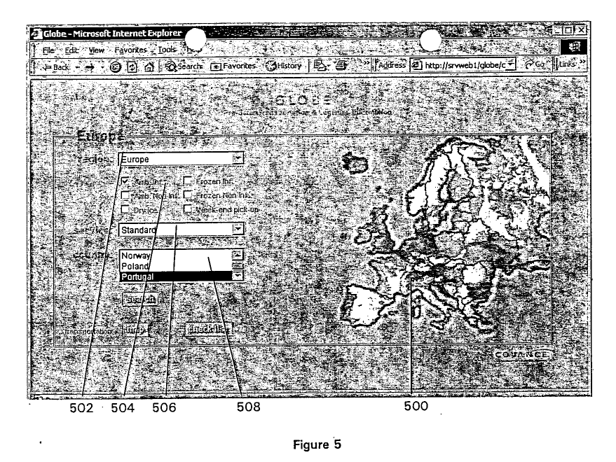

The conceptual screen shot of FIG. 5 illustrates features that may be included in a lower-tiered screen (i.e., a screen that is reached as a result of “drilling down”, or navigating from a top-level screen). In this illustrative embodiment the region “Europe” has been selected from the top-level screen. This screen acts as a parameter-selection screen. In accordance with the principles of the present invention, such a selection may be effected by an operator's clicking on a point within the European region of the displayed world map. A screen such as this may be used to search for specific services and service providers within a region. Such a search may be particularly helpful in the process of setting up a medical protocol that requires samples to be delivered to one or more centralized laboratories. Participants in such a protocol may be scattered over one or more regions within which and among which sample delivery services may vary widely. A map 500 displays countries included within a selected region and permits an operator to navigate to more specific information related to a sub-region, such as a country within Europe. A “Region” window 502 with drop-down menu includes a text area that indicates the currently chosen region (e.g., Europe) to an operator and allows an operator to select a different region (e.g., North America, Latin America, Europe, Middle East, Africa, or Asia). A plurality of regions may also be searched by “highlighting”, or otherwise selecting, more than one region from the pulldown menu. The selection of multiple regions may be effected, for example, using keyboard and/or mouse interaction techniques. Note that these regions may be defined independently of the regions serviced by central laboratories, as noted above. An interactive display area, a checkbox area, 504 provides for the selection of various carrier options upon which to search. For example, Amb. Inf., indicates ambient temperature, infectious samples; Amb. Non inf., indicates ambient temperature, non-infectious samples; Dry Ice, indicates that the carrier is capable of supplying dry ice to a participant in for shipment to a central laboratory along with a medical sample; Frozen Inf. indicates that the carrier will transport frozen, infectious samples; Frozen Non Inf. indicates that the carrier will transport frozen non-infectious samples; and Weekend pick up indicates that the carrier will pick up specimens on weekends. In this illustrative embodiment, countries that meet one or more of the parameter requirements selected by a user through interaction with the display are highlighted in the map region 500. For example, if a user selects “ambient infectious” and one or more carriers in France handle ambient samples, but not infectious samples, the map of France will nevertheless be highlighted. In an illustrative embodiment, the map will be highlighted only if at least one courier can handle ambient infectious samples. If the courier can handle ambient, but not infectious, samples, the country would not be available, and, consequently, when the country is “clicked on” the courier section would be empty. In this illustrative embodiment, procedures, holidays, transit times, and active sites will be displayed.

In this illustrative embodiment, a window 506 allows an operator to select the type of services to search for. That is, an operator may choose “standard” services, for example, to obtain data related to only those carriers that provide standard carrier services (such carriers may include Airborne, or TNT, for example) or an operator may choose premium services, in which case information related to carriers that provide premium services will be displayed (such carriers may include WC, Marken, or Ocasa, for example). In this illustrative embodiment a default setting, whereby the operator doesn't select a type of service, returns information related to all types of services. A window 508 permits an operator to select sub-regions for searching. In this illustrative embodiment, the sub-regions are countries within the European continent, and an operator may select multiple regions from the list for each search. In this illustrative embodiment, the “map” feature provides a summary of general services for a specific region. That is, in this illustrative embodiment each country may be assigned a specific color that corresponds to a general degree of difficulty of operating within the country, with, for example, nine different colors representing a range from most to least difficult. The checklist feature provides a list of questions that a user can answer and send to the appropriate logistics staff in order to propose the right service to the right protocol.

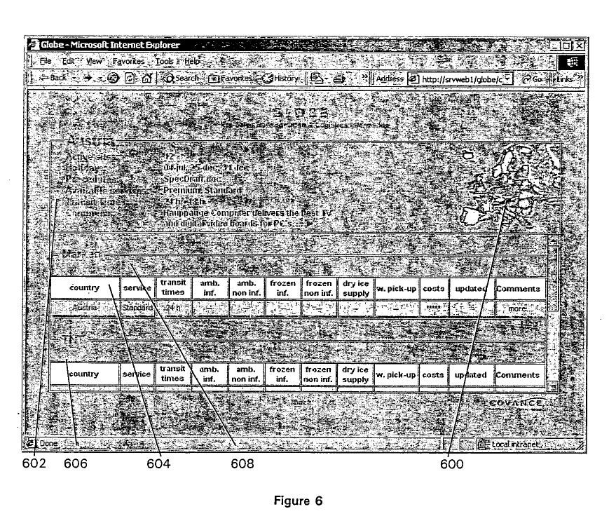

The illustrative conceptual screen shot of FIG. 6 includes information that may be displayed by a system in accordance with the principles of the present invention in response to an operator's selection of one or more divisions of the geopolitical region displayed in FIG. 5. In this illustrative example the selected division is Austria. That is, Austria has been selected from countries accessible from the “Europe” screen of FIG. 5. The one or more selected countries are accented 600 in the display (i.e., Austria in this illustrative embodiment). A screen area 602 lists information related to the one or more selected countries. The information fields in this area may include: Active Sites, Holidays, Procedures, Available Services, Transit Times, and Comments sections, for example. The “Active Sites” field may be used to indicate the number of investigators currently participating in a protocol within the selected country. The “Holidays” field may be used to indicate official Holidays in the selected country. Additional holiday-related information may be presented by the system in response to user input, such as clicking on the “Holidays” screen area. For example, the system may open a window that displays a calendar, with highlighted Holidays in response to a user's activation of the Holidays screen area. The “Procedures” display area may be used to display procedural logistics information. Such information may include import/export, customs or local authority requirements. The procedures display area may provide a link to a document located on a web server, where more detailed information may be obtained. More detailed information may be displayed in response to a user's selection of one or more listed documents, such as the document entitled SpecDraft.doc of this illustrative embodiment. The Transit Times region may be used to display the transit times, such as the average time needed to take one sample from a point of origin (e.g., and investigation center) to a point of destination (e.g., a central laboratory). When such average times are employed, they may include the time for pick-up, export procedures within customs or DG control, air or ground transportation, import procedures at customs, and final delivery. Each carrier within the selected region that provides the desired type of service will be listed with related information. In this illustrative example, these regions include a region 604 dedicated to the carrier Marken, and a region 606 dedicated to the carrier TNT. Rather than dedicating a large display area to the static display of all the logistics information for each of the carriers, information for each field may be activated by a user passing a mouse over a specific region. That is, for example, should a user pass a mouse over the “amb.inf.” header, the screen segment 608 will fill in with information related to whether Marken handles infectious samples at ambient temperatures within Austria. Displayed information may include, the type of service, transit times, whether the carrier can handle ambient/frozen, infectious/non-infectious samples, whether the carrier provides a supply of dry ice, whether the carrier provides pick-up service on the weekend (e.g., w.pick-up), costs, how recently the information has been updated, and general comments. It should be noted that couriers able to handle frozen specimens cannot always provide dry ice. Normally, only “premium” couriers can provide such service wherever they can handle samples. The service field may include a description that indicates that standard service implies that transportation is made through a couriers' own network, with pickup and delivery at a predetermined time, and that premium service implies that transportation is made through commercial airlines or customized services, and includes the ability to provide packing and dry ice. Cost information may be displayed in a number of ways, including, as illustrated here, through the use of icons. In this illustrative embodiment, the number of star icons displayed indicates a range of costs. That is, one star icon may be used to indicate a range of costs from $0.00 to $50.00, two star icons may indicate a range of costs from $51.00 to $100.00, and so on.

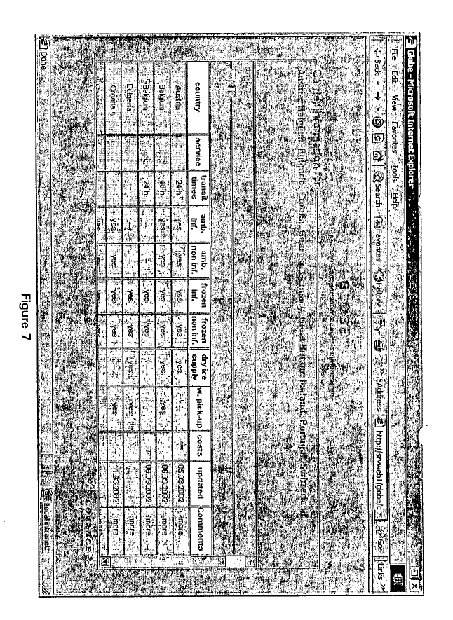

The conceptual screen shot of FIG. 7 illustrates a display in accordance with the principles of the present invention in which logistics information for a number of different countries are displayed. The countries in this illustrative embodiment are Austria, Belgium, Bulgaria, Croatia, Georgia, Germany, Great Britain, Iceland, Portugal, and Switzerland. The various information fields: service, transit times, amb. inf., amb. non inf., frozen inf., dry ice supply, w. pick-up, are as described in the discussions related to previous figures. Although this information is provided for a single carrier, TNT, in multiple countries in this illustrative example, such information may be displayed in this format for one or more carriers and one or more countries for each selected carrier.

A software implementation of the above described embodiment(s) may comprise a series of computer instructions either fixed on a tangible medium, such as a computer readable media, e.g. diskette, CD-ROM, ROM, or fixed disc, or transmittable to a computer system, via a modem or other interface device, such as communications adapter connected to the network over a medium. Medium can be either a tangible medium, including but not limited to, optical or analog communications lines, or may be implemented with wireless techniques, including but not limited to microwave, infrared or other transmission techniques. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, e.g., shrink wrapped software, preloaded with a computer system, e.g., on system ROM or fixed disc, or distributed from a server or electronic bulletin board over a network, e.g., the Internet or World Wide Web.

Although various exemplary embodiments of the invention have been disclosed, it will be apparent to those skilled in the art that various changes and modifications can be made which will achieve some of the advantages of the invention without departing from the spirit and scope of the invention. It will be apparent to those reasonably skilled in the art that other components performing the same functions may be suitably substituted. Further, the methods of the invention may be achieved in either all software implementations, using the appropriate object or processor instructions, or in hybrid implementations that utilize a combination of hardware logic, software logic and/or firmware to achieve the same results. Processes illustrated through the use of flow charts may not be strictly linear processes and alternative flows may be implemented within the scope of the invention. The specific configuration of logic and/or instructions utilized to achieve a particular function, as well as other modifications to the inventive concept are intended to be covered by the appended claims.

The foregoing description of specific embodiments of the invention has been presented for the purposes of illustration and description. It is not intended to be exhaustive or to limit the invention to the precise forms disclosed, and many modifications and variations are possible in light of the above teachings. The embodiments were chosen and described to best explain the principles of the invention and its practical application, and to thereby enable others skilled in the art to best utilize the invention. It is intended that the scope of the invention be limited only by the claims appended hereto.

What is claimed is:

1. A method of providing laboratory logistics information through a network connection comprising the steps of:
(A) storing laboratory logistics information in a machine-readable form;
(B) a controller displaying a map across a network connection, the map including one or more geopolitical regions for which laboratory logistics information is stored; and
(C) the controller responding to user input across a network connection by displaying laboratory logistics information associated with one or more geopolitical regions.

2. The method of claim 1 wherein step (C) includes the step of:
(C1) the controller displaying graphical geopolitical information and responding to user input to navigate the stored laboratory logistics information from a geopolitical perspective.

3. The method of claim 2 wherein the step (C1) includes the step of:
(C1A) displaying laboratory logistics information related to a geopolitical region selected by the user through interaction with a displayed map.

4. The method of claim 3 wherein the step (C1A) includes the step of:
(C1B) displaying the capabilities of one or more carriers that service the selected region.

5. The method of claim 4 wherein the step (C1B) includes the step of:
(C1C) displaying one or more carrier's capabilities regarding the handling of infectious samples.

6. The method of claim 4 wherein the step (C1B) includes the step of:
(C1D) displaying one or more carrier's capabilities regarding the handling of frozen samples.

7. The method of claim 4 wherein the step (C1B) includes the step of:
(C1E) displaying one or more carrier's capabilities regarding the availability of dry ice.

8. The method of claim 4 wherein the step (C1B) includes the step of:
(C1F) displaying information regarding the identity of carriers that serve the selected region.

9. The method of claim 4 wherein the step (C1B) includes the step of:
(C1G) displaying information regarding holidays in the region.

10. The method of claim 4 wherein the step (C1B) includes the step of:
(C1H) displaying information that identifies carriers within the selected region that provide infectious sample handling services;
(C1I) displaying information that identifies carriers within the selected region that provide frozen-sample handling services;
(C1J) displaying an estimate of transit time for carriers that provide services identified in steps (C1H) and (C1I).

11. The method of claim 4 wherein the step (C1B) includes the step of:
(C1K) displaying information that identifies carriers within the selected region that provide non-infectious sample handling services;
(C1L) displaying information that identifies carriers within the selected region that provide ambient temperature sample handling services;
(C1M) displaying an estimate of transit time for carriers that provide services identified in steps (C1K) and (C1L).

12. The method of claim 3 wherein the steps of displaying across a network connection comprises the step of displaying across an intranet connection.

13. The method of claim 3 wherein the steps of displaying across a network connection comprises the step of displaying across an Internet connection.

14. A method of providing laboratory logistics information comprising the steps of:
(A) storing laboratory logistics information in a machine-readable form in a location that is accessible through a network interface;
(B) a controller displaying a map across a network link, the map including one or more geopolitical regions for which laboratory logistics information is stored;
(C) the controller responding to user input across a network link by displaying laboratory logistics information associated with one or more geopolitical regions selected by the user through interaction with a displayed map, wherein the logistics information includes: the capabilities of one or more carriers that service the selected region, including the type of sample services a carrier provides, the expected transit time, and special services provided by an identified carrier; and
(D) the controller displaying contact information for one or more carriers identified in step (C).

15. The method of claim 14 wherein the sample type includes frozen.

16. The method of claim 14 wherein the sample type includes infectious.

17. The method of claim 14 wherein special services include weekend delivery.

18. An apparatus for providing laboratory logistics comprising:
data storage;
a controller configured to store laboratory logistics information in the data storage and to provide a network connection for access to the data storage; and
the controller further configured to display a map that includes geopolitical regions for which the laboratory logistics information has been stored and to respond to user input from the network connection by displaying laboratory logistics information associated with one or more geopolitical regions.

19. The apparatus of claim 18 wherein the controller is configured to display graphical geopolitical information and to respond to user input to navigate the stored laboratory logistics information from a geopolitical perspective.

20. The apparatus of claim 19 wherein the controller is configured to display laboratory logistics information related to a geopolitical region in response to a user's interaction with a displayed map.

21. The apparatus of claim 20 wherein the controller is configured to display the capabilities of one or more carriers that service the selected region.

22. The apparatus of claim 21 wherein the controller is configured to display or more carrier's capabilities regarding the handling of infectious samples.

23. The apparatus of claim 21 wherein the controller is configured to display one or more carrier's capabilities regarding the handling of frozen samples.

24. The apparatus of claim 21 wherein the controller is configured to display one or more carrier's capabilities regarding the availability of dry ice.

25. The apparatus of claim 21 wherein the controller is configured to display information regarding the identity of carriers that serve the selected region.

26. The apparatus of claim 21 wherein the controller is configured to display information regarding holidays in the region.

27. The apparatus of claim 21 wherein the controller is configured to display information that identifies carriers within the selected region that provide infectious sample handling services, to display information that identifies carriers within the selected region that provide frozen-sample handling services, and to display an estimate of transit time for carriers that provide such services.

28. The apparatus of claim 21 wherein the controller is configured to display information that identifies carriers within the selected region that provide non-infectious sample handling services, to display information that identifies carriers within the selected region that provide ambient temperature sample handling services, and to display an estimate of transit time for carriers that provide such services.

29. The apparatus of claim 20 wherein the controller is configured to display laboratory logistics information across an intranet connection.

30. The apparatus of claim 20 wherein the controller is configured to display laboratory logistics information across an Internet connection.

31. An apparatus for providing laboratory logistics information comprising: the steps of:
storage containing laboratory logistics information, the information from the storage accessible through a network interface;
a controller configured to display a map across a network link, the map including one or more geopolitical regions for which laboratory logistics information is stored;
the controller configured to respond to user input across the network link by displaying laboratory logistics information associated with one or more geopolitical regions selected by the user through interaction with a displayed map, wherein the logistics information includes: the capabilities of one or more carriers that service the selected region, including the type of sample services a carrier provides, the expected transit time, and special services provided by an identified carrier; and
the controller configured to display contact information for one or more of the carriers.

32. The apparatus of claim 31 wherein the controller is configured to display logistics information related to a carrier's capabilities in handling frozen samples.

33. The apparatus of claim 31 wherein the controller is configured to display logistics information related to a carrier's capabilities in handling infectious samples.

34. The apparatus of claim 31 wherein the controller is configured to display information related to a carrier's capabilities related to handling samples on non-business days.
